(19) United States
(12) Patent Application Publication
(10) Pub. No.: US 2026/0270460 A1
(43) Pub. Date: Sep. 10, 2026

(54) CODING UNIT BASED IMPLICIT NEURAL REPRESENTATION (INR)

(71) Applicant: InterDigital CE Patent Holdings, SAS, Paris (FR)

(72) Inventors: Francois SCHNITZLER, Saint Avé (FR); Pierre HELLIER, Thorigne-Fouillard (FR); Anne LAMBERT, Saint-Aubin-d’Aubigné (FR); Bharath Bhushan DAMODARAN, Vannes (FR)

(21) Appl. No.: 19/160,840

(22) PCT Filed: Feb. 16, 2024
(86) PCT No.: PCT/EP2024/053955

§ 371 Date: Aug. 28, 2025

(30) Foreign Application Priority Data
Mar. 3, 2023 (EP) 23305282.8

(51) Int. Cl. H04N 19/463; H04N 19/176; H04N 19/436

(52) U.S. Cl. CPC H04N 19/463; H04N 19/176; H04N 19/436

(57) ABSTRACT

In one implementation, an image or 3D scene is partitioned into multiple coding units with variable sizes. An INR network is obtained for each coding unit to compress the signal. To achieve a lower bitrate, one or more neural layers of previous coding units can be reused for the current coding unit. Several mechanisms to select the layers to reuse or to select reference CUs are provided. For example, the encoder can define the layers to be reused. The encoder can also use a number of bits, each bit indicating that a layer is reused or not. Alternatively, the encoder can specify the index of the layers that are reused. Different ways are also provided to generate a bitstream including partitioning information of the coding tree units and the parameters of different INR networks.

### TECHNICAL FIELD

The present embodiments generally relate to a method and an apparatus for neural compression.

### BACKGROUND

Neural compression or learning-based compression is the application of neural networks and other machine learning methods to data compression. Those techniques are currently being investigated by MPEG, and there is a new ad-hoc group which focuses on the Implicit Neural Representation-based (INR-based) compression within Working Group 4. Typically, INR-based compression techniques have a far lower computational complexity than end-to-end neural compression approaches.

### SUMMARY

According to an embodiment, a method of decoding video data representative of an image or a 3D scene is presented, comprising: obtaining parameters of at least a first INR (Implicit Neural Representation) network for a reference block of a block of said video data; obtaining parameters associated with at least a second INR network for said block of said video data, based on at least part of said parameters of said at least first INR network for said reference block; obtaining coordinates for said block of said video data; and reconstructing said block corresponding to said coordinates for said block, based on said at least second INR network for said block.

According to another embodiment, a method for encoding video data representative of an image or a 3D scene is presented, comprising: obtaining at least a first INR (Implicit Neural Representation) network for a reference block of a block of said video data; obtaining at least a second INR network for said block; and encoding parameters of said at least second INR network, wherein said parameters of said at least second INR are encoded by using at least part of parameters of said at least first INR network.

According to another embodiment, an apparatus for decoding video data representative of an image or a 3D scene is presented, comprising one or more processors and at least one memory coupled to said one or more processors, wherein said one or more processors are configured to: obtain parameters of at least a first INR (Implicit Neural Representation) network for a reference block of a block of said video data; obtain parameters associated with at least a second INR network for said block of said video data, based on at least part of said parameters of said at least first INR network for said reference block; obtain coordinates for said block of said video data; and reconstruct said block corresponding to said coordinates for said block, based on said at least second INR network for said block.

According to another embodiment, an apparatus for encoding video data representative of an image or a 3D scene, comprising one or more processors and at least one memory coupled to said one or more processors, wherein said one or more processors are configured to: obtain at least a first INR (Implicit Neural Representation) network for a reference block of a block of said video data; obtain at least a second INR network for said block; and encode parameters of said at least second INR network, wherein said parameters of said at least second INR are encoded by using at least part of parameters of said at least first INR network.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding video data according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a simple neural network used for Implicit Neural Representation (INR).

FIG. 3 illustrates a typical process to encode a signal using INR.

FIG. 4 illustrates a neural architecture typical of hybrid INR.

FIG. 5 illustrates kiloNERF.

FIG. 6 illustrates a proposed architecture of coding unit based INR, according to an embodiment.

FIG. 7 illustrates an encoding procedure using INR, according to an embodiment.

FIG. 8 illustrates a few possible bitstream formats for INR-based video compression, according to an embodiment.

FIG. 9 illustrates a decoding procedure using INR, according to an embodiment.

### DETAILED DESCRIPTION

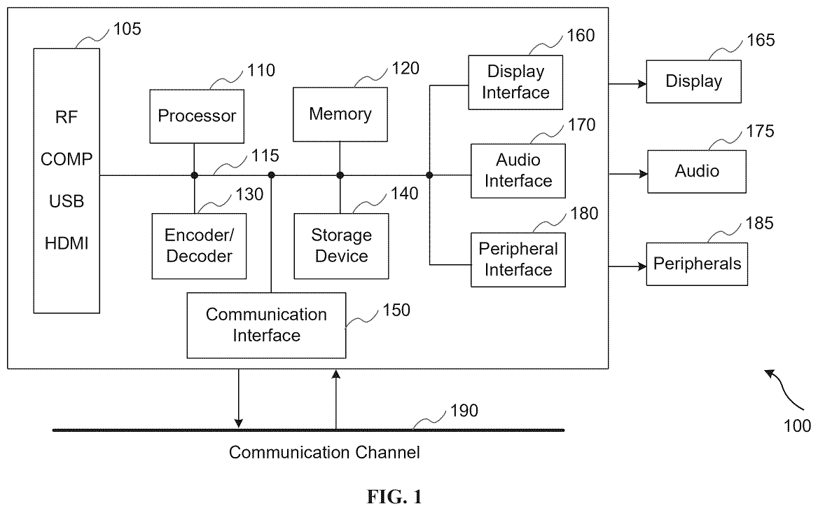

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, VVC, MPEG VCM, or MPEG INVR.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface Ics or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

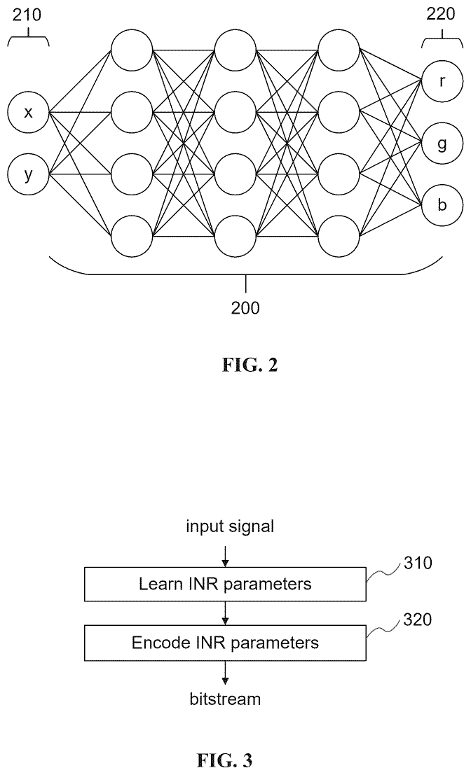

FIG. 2 illustrates a simple neural network used for implicit neural representation (INR). Such a neural network used for INR can be referred to as an INR network. For clarity, we use for illustration a 2D signal such as an image, but INR can be used for signals of any dimension. INR parameterizes a signal as a function (200), which takes coordinates (210) as input and outputs potentially approximated values (220) of a signal at these coordinates. INR has recently been applied to images, 2D videos or 3D objects among other applications. In the image case, the inputs (210) can be pixel coordinates (x, y) and the INR outputs (220) the color values (r, g, b) of the input pixels. In the video case, the output is similar, but the input can include the frame index t in addition to pixel coordinates. The INR can be used to reconstruct a signal by computing the signal values for every necessary coordinate inputs.

An INR network (200) is typically a neural network composed of multiple neural layers, such as fully connected layers. In FIG. 2, the network has four neural layers. Intermediate outputs are represented by circles. Each neural layer can be described as a function that first multiplies the input by a tensor, adds a vector called the bias and then applies a nonlinear function on the resulting values. In this document, we may also refer to “neural layer” simply as “layer.” The shape (and other characteristics) of the tensor and the type of non-linear functions are called the architecture of the network. We will denote the values of the tensor and the bias by the term “weights”. The weights and, if applicable, the parameters of the non-linear functions, are called the parameters θ of the network. The architecture and the parameters define a “model”. We will use f_{θ} to denote an INR function parameterized by θ.

FIG. 3 illustrates a typical process to encode a signal using INR. This is done by optimizing the parameters θ (or a subset of them) of the INR network to reconstruct (310) the signal and encoding (320) parameters to create the output bitstream. For an image I of size (M×N), the parameters θ or (the chosen subset) can for example be optimized by minimizing the following loss function:

$$Loss = D ( I , {f}_{θ} ) + λ R ( θ ) \qquad ( 1 )$$

$${D}_{MSE} = \frac{1}{MN} {\sum }_{x , y} {( I ( x , y ) - {f}_{θ} ( x , y ) )}^{2} \qquad ( 2 )$$

where D is a distortion which quantifies the difference between the image predicted (reconstructed) by f_{θ} and the original image I, R is the bitrate of the encoded parameters and λ a trade-off parameter between D and R. D could be any differentiable distortion measure, such as mean squared error as Eq. (2). M and N are the width and height of an image. Other metrics such as LPIPS (Learned Perceptual Image Patch Similarity) can also be used in this case. The optimization of the weights θ is typically performed by a machine learning approach such as a batch gradient descent method.

To decompress the signal, f_{θ} is evaluated at all relevant coordinates. These coordinates can be selected at decoding. A typical choice would be all pixel coordinates for an image or video. As an example, for a 256×256 pixel image, these coordinates could be all pairs (x, y) for all x∈{0,1, . . . ,255} and y∈{0,1, . . . ,255}. Other choices are possible, for example to upsample, downsample or extend the original image.

Using one INR network globally for the whole signal makes learning difficult, as all parameters contribute to all values and lead to a large network as it must encode all details of the signal. Two approaches have been developed to work around this issue.

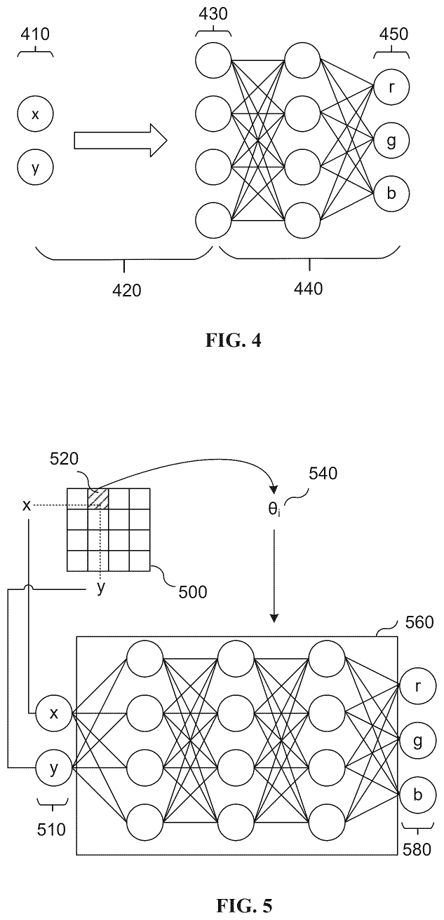

FIG. 4 illustrates a neural architecture typical of the first class of such approaches, Hybrid INR, such as COOL-CHIC. The input coordinates (410) are first mapped to a vector of features (430). Such a mapping (420) can for example rely on a lookup table, a partition of the signal, a hash function and/or a linear combination of features. These features are then used as input for an INR network (440) that outputs the value (450) of the signal for the input coordinates (410). Using such an architecture rather than a plain INR network helps to handle local features of the input signal. Indeed, the features for a given location are generally completely or mostly independent from features at other coordinates and can be tailored to each location.

FIG. 5 illustrates another approach: kiloNERF. In this approach, the signal domain (500) is divided into non-overlapping windows of a predefined size. To each window is associated a set of different INR parameters. The values of input coordinates (510, e.g., pixel coordinates x and y in FIG. 5, 3D positions and viewing direction in the original kiloNERF approach for 3D scene) are first mapped to index i of the corresponding window (520) of the signal domain. The corresponding window (520) is the window that contains the point of these input coordinates. Parameters θᵢ (540) associated to this window are then selected and used to parameterize an INR network (560). This network is then used to transform the input coordinates (510) into the values (580) of the signal at these coordinates. KiloNERF proposes for example to replace a large network composed of nine layers of output size 256, one layer of output size 128 and one layer of output size 3 by smaller networks composed of four layers of output size 32 and one layer of output size 3 when encoding a 3D scene.

As described above, using one INR network forces the network to encode everything, meaning that all parameters contribute to the whole signal. This makes training difficult and may lead to a large network. Existing hybrid INR solutions train faster but do not fully exploit the structure of the signal, as hybrid approaches uses the same neural network parameters for the whole signal, thus requiring a large network to encode all possible transforms. kiloNERF learns one different INR for each part of the signal but these parts are all at the same size, leading either to a lot of redundancy when these parts are smaller than an area of the signal containing similar content, or to large networks when the characteristics of the signal vary a lot within different areas of that part. Both cases can happen simultaneously for the same signal, as a signal such as an image or video typically contain areas with different level of details. In addition, kiloNERF is specialized for 3D data and does not address picture or video coding. Encoding the INRs is also not considered in kiloNERF.

In this document, we propose solutions to better handle local contents using INR-based compression. We propose to consider the input domain as a coding tree unit (CTU) and to partition it into coding units (CU) and to learn a set of different values for the INR parameters for each coding unit. Furthermore, we propose several mechanisms to reuse layers from previous CUs to achieve a lower bitrate. We also propose different ways to generate a bitstream for the signal encoding including the coding tree units and the parameters of the different INRs.

### CU Partitioning

To better handle local contents in a signal in INR-based compression, it is advantageous to learn an INR network for parts of the signal. To limit the redundancy in the encoding caused by these many INRs, we propose to optimize the division of the signal using coding units.

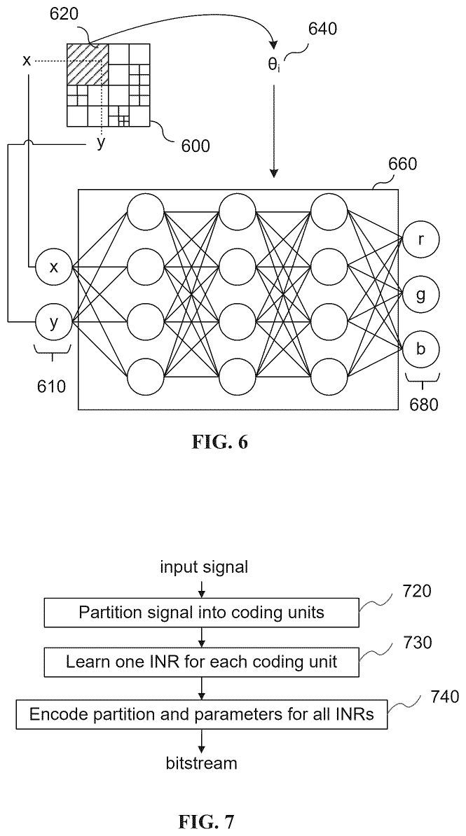

A resulting architecture is illustrated in FIG. 6 for an image, according to an embodiment. The domain (600) of the signal is partitioned into coding units (CU) using quadtree recursive partitioning. Other recursive partitioning could be used, such as binary, ternary trees or geometric partitioning. More generally, any partitioning methods that generate blocks at variable block sizes can be used. For each coding unit, a specific set of INR parameters α; (640) is trained to encode the signal values within this coding unit. The signal is reconstructed as follows. Inputs coordinates (610) are first used to identify the coding unit (620) that contains the points defined by these coordinates. The associated parameters α; (640) are used to parameterize an INR network (660). Finally, the input coordinates (610) are used as input of this network to compute the reconstructed signal value (680) at these coordinates.

An encoding procedure using INR is illustrated in FIG. 7, according to an embodiment. The input signal is first partitioned (720) into coding units using quadtree partitioning. In step 730, one INR is learned for each coding unit. Finally at step 740, parameters of each INR network and parameters indicating the signal partition are encoded to construct a bitstream.

Many approaches are possible to partition the signal into coding tree units (720). A brute force approach is possible, where all possible partitions are considered. Another possible approach is a greedy search where an initial CU covering the whole signal is incrementally divided by evaluating the impact of a CU split and splitting is done if the impact in terms of rate/distortion is positive. In other words, a CU is split further if its encoding (together with its INR) is less advantageous in terms of rate distortion than encoding its children. It is also possible to build the CU partition without learning INR networks. As an example, both a brute force or a greedy search approach could optimize other characteristics of the CUS, such as pixel mean, variance, texture and/or any other statistics of the signal within the considered CUs.

In step 730, learning INR for a CU is identical to learning a network for a signal. In other words, the CU itself is considered as a signal. Note that some approaches for partitioning (720) the signal may require the computation and the evaluation of one INR per possible coding unit. In that case step 730 can involve no learning but only a retrieval of networks learned in previous step 720. Finally at step 740, parameters indicating the partition of the signal (the CUs) and the associated INR parameters are encoded to create a bitstream for transmission or for later use. This may involve the use of entropy coders.

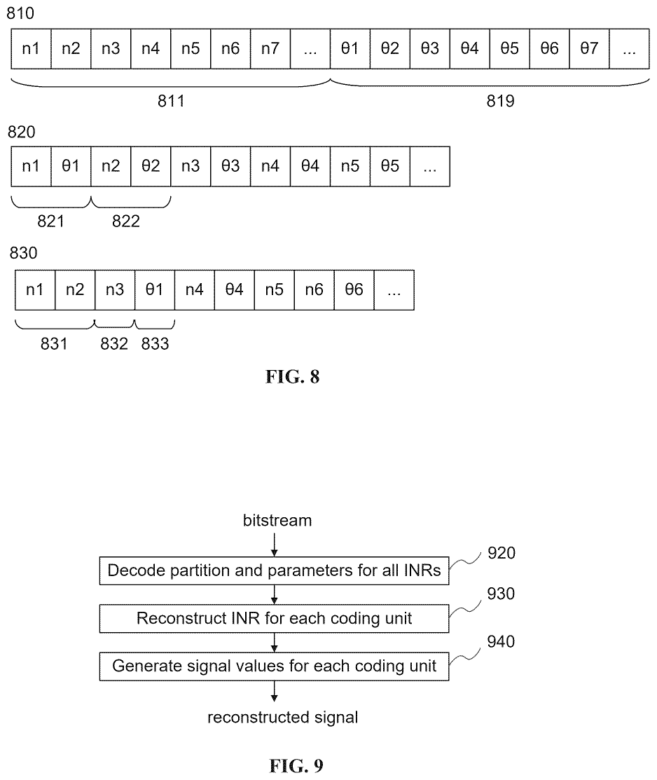

There are several possible approaches to construct the bitstream from the structure described above. FIG. 8 illustrates a few possible bitstream formats, according to an embodiment. In the first example (810), the bitstream contains two parts. The first part (811) contains the characteristic of the CUs such as for example size and/or locations. The different coding units are described sequentially (n1, n2 . . . ). For the locations, it is possible to use a predefined order, such as starting point in the signal and position of next CU in the bitstream with respect to the CUs already described. We can also use the method used in the video coding standard, for example, in HEVC or VVC, to signal the partitioning. The second part (819) then contains the INR parameters for each CU, arranged sequentially in the same or a different order (θ₁, θ₂, . . . ).

In a second possible example (820), the CU characteristics are still described sequentially but each set of INR parameters in the bitstream comes immediately after the CU description. In the illustration, the first set of parameters θ₁ immediately follows the description of the first CU (821). Next in the bitstream (822) come the characteristics of the second CU and the second set of INR parameters. And so on until all CU and parameter sets have been described.

The two example above only describe the final coding units. The bitstream could also contain different encoding for the partition of the signal. For example, the partition can be described as a tree including nodes that are further divided, as in example (830). In this example, n1 and n2 are further split (831), so each of these nodes of the quadtree has four children. N3 is the first node that is not split, so n3 is followed by the INR parameters (θ₁) for this unsplit CU. N4 is the second child of n2 and is also not split so comes with an INR (θ₄). N5 is the third children of n2, is split and has four children. N6 is the first children and is not split. The characteristics (831) of these nodes are first included in the bitstream and could be as simple as one bit to indicate the node is split. When a CU is not split and is associated to a set of parameters, the CU characteristics (832) and the parameters (833) are included in the bitstream.

The parameters within a set can be arranged in any order. The bitstream could be further modified or entropy coded by any available entropy coder such as arithmetic encoding of CABAC (Context-Adaptive Binary Arithmetic Coding).

A decoding procedure using INR is illustrated in FIG. 9, according to an embodiment. The input is a bitstream. From this bitstream, the partition information and all sets of INR parameters are decoded (920). Then, the networks are reconstructed (930) for each coding unit. Finally, the signal values are computed by performing inference using the appropriate INR for each CU and using as inputs all coordinates within each CU. Variants are possible, such as constructing the networks all at once and then generating the values; constructing the networks and computing the values per CU sequentially, one at a time; modifying the order of the input coordinates within a CU; using batches of coordinates as input to perform parallel computation of values.

### Layer Reuse

To further exploit local redundancy in the signal, we additionally propose to reuse the parameters of layers already used for nearby coding units (the reference CUs). In such a situation, the bitstream will also include elements indicating the layers reused, significantly reducing the size of the bitstream. In such situation, the bitstreams of the layers described in the above are slightly modified to encode the reused layers in addition to the parameters for the layers that are not reused. We describe several possible solutions, and some of them can be used in combination. These solutions will modify the encoder (FIG. 7, 740) and INR decoding (FIG. 9, 920).

Any of these solutions may also impact the learning procedure (FIG. 7, 730). For example, when processing a new CU, a subset of layers of the INR may be initialized to the values of a close CU and frozen, i.e., their parameters are not trained. Different combinations of frozen layers may also be considered, and the result achieving the best Rate-Distortion (R-D) tradeoff chosen by the encoding algorithm.

The first set of solutions relate to the definition of the layers to reuse. One option is to specify an ordering of the layers, either static, or dynamically chosen by the encoder. When the ordering is static, both the encoder and decoder know the ordering and the ordering information need not to be signaled in the bitstream. When the ordering is dynamic, the ordering information is signaled in the bitstream, for example, at the beginning of the signal, at any interval, for example at the beginning of each CU, for a set number of CUs, at the beginning of a CTU, at set intervals in the signals. The number of CUs reusing layers when a particular ordering is valid can use a default configuration, or can also be dynamic and specified in the bitstream, before reversing to a default configuration. Such an ordering can for example be from first to last layers, in the reverse order or any random order. Then, when encoding an INR network, the bitstream may only contain the number of layers that are reused (rather than the parameters of these reused layers), using a positive integer value. Negative integer values could be used for this parameter or in another field of the bitstream to specify the number of layers reused at the end of the ordering. As an example, a value of 3 would indicate that the first three layers of the ordering are reused, and a value of −3 would indicate that the last three layers of the ordering are reused.

When encoding parameters of an INR network, another option is to use a number of bits equal to the number of layers of the INR network of the reference CU. Each bit indicates (with one value) that the layer is reused or (with the other value) that the layer is not reused. The procedure above can also be applied to any partition of the INR network rather than to layers. Examples include groups of layers, group of neurons or a mix of both.

Another option is to specify the index of the layers that are reused or of the layers that are not reused. The option chosen could also be chosen dynamically and included in the bitstream.

The layers reused can be specified in the bitstream at any interval, for example at the beginning of each CU, for a set number of CUs, at the beginning of a CTU, at set intervals in the signals. Furthermore, there are multiple ways to associate a layer reuse configuration to the CU. One may signal the layers reuse for every CU individually, for groups of CUs by including a number of CUs where this configuration is valid or by listing CU identifiers associated to a particular configuration. The number of CUs during when a particular layer reuse configuration is valid can also be dynamic and specified in the bitstream, before reversing to a default configuration. It can also be decided by the standard. It is also possible to have a default layer reuse configuration, either known to both the encoder and decoder or signaled in the bitstream. In that case, when no layer reuse configuration is specified for a CU, the default configuration is used.

The second set of solutions relate to the reference CU used, i.e., the CU associated to the INR network whose layer parameters are reused.

Perhaps the most straightforward option is to use the reverse of the ordering of the CUS in the bitstream, as the CU can be encoded sequentially in the bitstream as in FIG. 8. In other words, when specifying the reference CU for the current CU, the latest encoded CU would come first in the ordering and be indexed by e.g., 1, the second to the latest would come second in the ordering and be indexed by e.g., 2 and so on. If it is different, another option is to use the reverse of the ordering of the processing of the CU by the encoder, so that the latest CU that was encoded before the current CU comes first in the ordering.

Another option is to specify a different ordering of the CU, either static, or dynamically chosen by the encoder. In the latter case, this ordering is specified in the bitstream at any interval, for example at the beginning of each CU, for a set number of CUs, at the beginning of a CTU, at set intervals in the signals. The number of CUs during when a particular ordering is valid can also be dynamic and specified in the bitstream, before reversing to a default configuration. It can also be entropy coded. One other possible ordering is by proximity, where proximity can be defined for example by distance in terms of the center of the CU, in terms of distance between the border of the CU or by any other geometric method to measure the distance between two shapes and where that distance or a combination of these distances can be measured by any norm such as L1, Euclidian, or any other mathematical function. Ties can be broken by any approach, including by the processing order of the CU, by size or based on a direction. Yet another option is to apply any of these variants to a fixed or dynamic subset of the CUs processed previously, to account for a possibly limited memory of the encoder. The reverse of any ordering specified above is also possible.

With any ordering, one option is to always use as a reference CU the last CU, the first CU or the CU with a chosen position of the ordering, for example the third or fourth CU of the ordering.

Another option is to allow the encoder to choose the reference CU. Then, when encoding an INR network and reusing layers, the bitstream must include an identifier for the reference CU, such as the index of the CU in the ordering. As an example, a value of 3 would indicate that the CU number 3 in the ordering is used as a reference.

These two sets of solutions that relate to the choices of reference CUs and of the layers to reuse are independent and can be combined freely.

In the above, the proposed methods are mainly described with respects to 2D video compression. However, INR is investigated for many other signals, in particular 3D scenes or objects, and the proposed methods can be used for any signal.

While in the above the unmodified coordinates of the image are used as input and rgb values are output. More generally, the input/output can be in other representations. For example, the input can be normalized coordinates, or the output can be in the YUV format. In addition, the image itself could also be encoded differently, for example, the output could be Fourier or Cosine transforms coefficients. Furthermore, the domain of the signal can be partitioned by other methods than quadtree recursive partitioning, for example ternary trees or geometric partitioning. More generally, any partitioning methods that generate blocks at variable block sizes can be used.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of decoding video data representative of an image or a 3D scene, comprising:
obtaining parameters of at least a first INR (Implicit Neural Representation) network for a reference block of a block of said video data;
decoding a signal indicative of which one or more neural layers of said at least a first INR network are reused by at least a second INR network;
obtaining parameters associated with said at least a second INR network for said block of said video data, based on said one or more neural layers of said at least a first INR network for said reference block;
obtaining coordinates for said block of said video data; and
reconstructing said block corresponding to said coordinates for said block, based on said at least a second INR network for said block.

2-5. (canceled)

6. The method of claim 1, wherein said signal indicates a number of first one or more neural layers of said at least a first INR network to be used by said at least a second INR network.

7. The method of claim 1, wherein said signal indicates a number of last one or more neural layers of said at least a first INR network to be used by said at least a second INR network.

8. The method of claim 1, further comprising:
decoding data indicating which block is used as said reference block for said block.

9. The method of claim 1, wherein said block and said reference block are allowed to have different block sizes.

10. An apparatus for decoding video data representative of an image or a 3D scene, comprising one or more processors and at least one memory coupled to said one or more processors, wherein said one or more processors are configured to:
obtain parameters of at least a first INR (Implicit Neural Representation) network for a reference block of a block of said video data;
decode a signal indicative of which one or more neural layers of said at least a first INR network are reused by at least a second INR network;
obtain parameters associated with said at least a second INR network for said block of said video data, based on said one or more neural layers of said at least a first INR network for said reference block;
obtain coordinates for said block of said video data; and
reconstruct said block corresponding to said coordinates for said block, based on said at least a second INR network for said block.

11-14. (canceled)

15. The apparatus of claim 10, wherein said signal indicates a number of first one or more neural layers of said at least a first INR network to be used by said at least a second INR network.

16. The apparatus of claim 10, wherein said signal indicates a number of last one or more neural layers of said at least a first INR network to be used by said at least a second INR network.

17. The apparatus of claim 10, wherein said one or more processors are further configured to:
decode data indicating which block is used as said reference block for said block.

18. The apparatus of claim 10, wherein said block and said reference block are allowed to have different block sizes.

19-20. (canceled)

21. A method for encoding video data representative of an image or a 3D scene, comprising:
obtaining at least a first INR (Implicit Neural Representation) network for a reference block of a block of said video data;
encoding a signal indicative of which one or more neural layers of said at least a first INR network are reused in at least a second INR network;
obtaining said at least a second INR network for said block; and
encoding parameters of said at least a second INR network, wherein said parameters of said at least a second INR are obtained by using said one or more neural layers of said at least a first INR network.

22. The method of claim 21, wherein said signal indicates a number of first one or more neural layers of said at least a first INR network to be used by said at least a second INR network.

23. The method of claim 21, wherein said signal indicates a number of last one or more neural layers of said at least a first INR network to be used by said at least a second INR network.

24. The method of claim 21, further comprising:
encoding data indicating which block is used as said reference block for said block.

25. The method of claim 21, wherein said block and said reference block are allowed to have different block sizes.

26. An apparatus for encoding video data representative of an image or a 3D scene, comprising one or more processors and at least one memory coupled to said one or more processors, wherein said one or more processors are configured to:
obtain at least a first INR (Implicit Neural Representation) network for a reference block of a block of said video data;
encode a signal indicative of which one or more neural layers of said at least a first INR network are reused in at least a second INR network;
obtain said at least a second INR network for said block; and
encode parameters of said at least a second INR network, wherein said parameters of said at least a second INR are obtained by using said one or more neural layers of said at least a first INR network.

27. The apparatus of claim 26, wherein said signal indicates a number of first one or more neural layers of said at least a first INR network to be used by said at least a second INR network.

28. The apparatus of claim 26, wherein said signal indicates a number of last one or more neural layers of said at least a first INR network to be used by said at least a second INR network.

29. The apparatus of claim 26, wherein said one or more processors are further configured to:
encode data indicating which block is used as said reference block for said block.

30. The apparatus of claim 26, wherein said block and said reference block are allowed to have different block sizes.
